(19) United States
(12) Patent Application Publication
(10) Pub. No.: US 2015/0069029 A1
(43) Pub. Date: Mar. 12, 2015

(54) WELD SEQUENCE EDITOR

(71) Applicant: Lincoln Global, Inc., City of Industry, CA (US)

(72) Inventor: JOSEPH A. DANIEL, SAGAMORE HILLS, OH (US)

(73) Assignee: Lincoln Global, Inc., City of Industry, CA (US)

(21) Appl. No.: 14/132,496

(22) Filed: Dec. 18, 2013

Related U.S. Application Data
(60) Provisional application No. 61/876,245, filed on Sep. 11, 2013.

(51) Int. Cl. B23K 9/095; B23K 9/10

(52) U.S. Cl. CPC B23K 9/0953; B23K 9/1062
USPC 219/125.1

(57) ABSTRACT

A weld sequence editor (WSE) for generating a weld sequence used by a welding job sequencer. Systems and methods to help a user generate a weld sequence are provided. The weld sequence editor allows a user to create a flow chart of the functions for completing a set of work instructions and allows the user to organize the functions into logical groups of steps. The logical groups of steps may be numbered, named, and the first function of each group may be identified. When a weld sequence is executed, each logical group is a defined visible step to an operator. The logical groups are used to organize information and progress through a set of work instructions while multiple background functions execute without complicating the operator's view of the work flow. The weld sequence editor provides a method to organize the same work instructions into a detailed viewpoint for a user of the editor, and a summarized viewpoint for the operator of a work cell.

This U.S. patent application claims the benefit of and priority to U.S. provisional patent application Ser. No. 61/876,245 filed on Sep. 11, 2013, which is incorporated by reference herein in its entirety.

### TECHNICAL FIELD

Embodiments of the present invention relate to arc welding and the like. More particularly, certain embodiments of the present invention relate to systems and methods for generating and editing welding sequences to be used by a welding job sequencer.

### BACKGROUND

In the related art, work cells are used to produce welds or welded parts. There are at least two broad categories of work cells, including robotic work cells and semi-automatic work cells.

In robotic work cells, the scheduling and performing of welding operations is largely automated, with little operator involvement. Thus, these cells generally have a relatively low labor cost and a relatively high productivity. However, their repeating operations cannot easily adapt to varying welding conditions and/or sequences.

In contrast, semi-automatic work cells (i.e., work cells involving at least some operator welding) generally provide less automation vis-à-vis robotic work cells, and accordingly have a relatively higher labor cost and a relatively lower productivity. Nevertheless, there are many instances where using a semi-automatic welding work cell can actually be advantageous over robotic work cells. For example, a semi-automatic welding work cell can more easily adapt to varying welding conditions and/or sequences.

Unfortunately, when welding more complex assemblies in related art semi-automatic work cells, multiple different welding schedules are often required for different types of welds on different parts of an assembly. In many systems, when a different welding schedule must be utilized, the operator is required to stop welding operations and manually adjust the output of the semi-automatic equipment according to the new schedule. In some other systems, this manual adjustment is eliminated by storing particular schedules in the work cell. Nevertheless, even in such systems, the operator still needs to cease welding operations and push a button to select the new welding schedule before he may continue welding.

Neither of these practices for setting a different welding schedule is particularly efficient. Thus, in practice, the number of welding schedules used in a semi-automatic work cell is often reduced in order to eliminate the need for constant adjustment of the output of the semi-automatic equipment. While this reduction of welding schedules makes the overall operation easier for the welder, the forced simplification of this approach can lead to reduced productivity and lower overall quality.

Additionally, when abiding by strict quality control specifications, it is sometimes necessary to perform welds in a specific sequence, verify that each weld is performed with a given set of conditions, and monitor the output of the equipment during the welding operations. In a robotic work cell, these requirements are easily fulfilled. However, in a semi-automatic work cell, these requirements are susceptible to human error, since the operator must keep track of all of these aspects in addition to performing the welding operations themselves.

An illustrative example of the above problems is shown in the related art semi-automatic welding method diagrammatically represented in FIG. 1. In this method, each of the various scheduling, sequencing, inspection and welding operations are organized and performed by the operator (i.e., the welder) himself. Specifically, the operator begins the welding job at operation 10. Then, the operator sets up the welding equipment according to schedule A, at operation 20. Next, the operator performs weld #1, weld #2, and weld #3 using welding schedule A at operations 22, 24 and 26. Then, the operator stops welding operations and sets up the welding equipment according to schedule B at operation 30. Next, the operator performs weld #4 using welding schedule B at operation 32. Then, the operator checks the dimensions of the assembly at operation 40, and sets up the welding equipment according to schedule C at operation 50. Next, the operator performs weld #5 and weld #6 using welding schedule C at operations 52 and 54. After the welding operations are completed, the operator visually inspects the welded assembly at operation 60, and completes the welding job at operation 70.

Clearly, the method shown in FIG. 1 depends on the operator to correctly follow the predefined sequencing for performing welds and inspections, to accurately change between welding schedules (such as at operation 30), and to perform the welding itself. Errors in any of these responsibilities can result either in rework (if the errors are caught during inspection at operation 60) or a defective part being supplied to the end user. Further, this exemplary semi-automatic welding method hampers productivity, because the operator must spend time configuring and reconfiguring weld schedules.

The above problems demand an improvement in the related art system.

### SUMMARY

A weld sequence editor (WSE) for generating a weld sequence used by a welding job sequencer is provided. The weld sequence editor has a graphical user interface providing a tool bar section, a function selection section, and a programmable flowchart section. The programmable flowchart section is configured to provide a space for defining groups of steps and programming the detailed functional steps for those groups for a welding sequence, and for programming the functional flow through those groups to define a welding sequence.

Systems and methods to help a user generate a weld sequence are provided. A weld sequence editor allows a user to create a flow chart of the functions for completing a set of work instructions and allows the user to organize the functions into logical groups of steps. The logical groups of steps may be numbered, named, and the first function of each group may be identified. When a weld sequence is executed, each logical group is a defined visible step to an operator. The logical groups are used to organize information and progress through a set of work instructions while multiple background functions execute without complicating the operator's view of the work flow. The weld sequence editor provides a method to organize the same work instructions into a detailed viewpoint for a user of the editor, and a summarized viewpoint for the operator of a work cell.

In one embodiment, a weld sequence editor is provided. The weld sequence editor includes a computer having at least one processor, a computer memory, and a display device. The weld sequence editor further includes a weld sequence editor software application stored on the computer memory including computer-executable instructions configured to be executed by the at least one processor. The weld sequence editor software application is configured to provide a graphical user interface having a tool bar section, a function selection section, and a programmable flowchart section. The programmable flowchart section is configured to provide a space for a user to generate a welding sequence for assembling a part by defining functional weld sequence groups, programming one or more functional weld sequence steps for each of the functional weld sequence groups, and programming the functional flow through the functional weld sequence groups. The weld sequence editor software application may be configured to generate an electronic welding sequence file having the welding sequence generated by the user. The computer may include a communication device configured to output the welding sequence file for use by a welding job sequencer. The communication device may be configured as a wireless communication device. The computer may be configured as one or more of a tablet computer, a desktop computer, a hand-held mobile device, or a workstation. The display device may be a touch-screen display device configured to facilitate use of the graphical user interface. The weld sequence editor may include a user input device providing one or more of a computer keyboard and a computer mouse to facilitate use of the graphical user interface.

In one embodiment, a welding system is provided. The welding system includes the weld sequence editor as described above herein. The welding system also includes a welding job sequencer configured to implement a welding sequence, and a welding work cell having a welding power source configured to be used by an operator to produce one or more welded parts in accordance with the welding sequence. The welding system may include a display device operatively connected to the welding job sequencer. The display device may be a touch-screen (touch-sensitive) display device providing user input capability. The welding work cell may include one or more of a wire feeder, a welding cable, a welding tool, consumable welding wire, a consumable welding electrode, a non-consumable welding electrode, a workpiece connector, and one or more workpiece parts to be welded. The welding job sequencer may be configured to interact with one or more of the welding power source, the wire feeder, or the welding tool when implementing the welding sequence. The welding sequence editor may include one or more of a tablet computer, a desktop computer, a hand-held mobile device, or a workstation. The welding system may include a user input device providing one or more of a computer keyboard and a computer mouse to facilitate use of the welding job sequencer by an operator.

In one embodiment, a method of generating a welding sequence is provided. The method includes defining functional weld sequence groups in a programmable flowchart section of a graphical user interface provided by a weld sequence editor software application running on a computer. The method also includes selecting functional icons, representative of functional weld sequence steps, from a function selection section of the graphical user interface and populating the functional weld sequence groups with the selected functional icons in the programmable flowchart section. The method further includes linking the functional icons and the functional weld sequence groups in the programmable flowchart section to program a functional flow through the functional weld sequence groups of functional weld sequence steps, resulting in a welding sequence. The method may further include exporting the welding sequence to an electronic file using a tool bar section of the graphical user interface, where the electronic file is stored in an electronic memory of the computer. The method may also include wirelessly transmitting the electronic file from the computer to a welding job sequencer component. The method may further include using the graphical user interface to modify the welding sequence by one or more of deleting a functional weld sequence step from a functional weld sequence group or adding a functional weld sequence step to a functional weld sequence group. The method may also include using the graphical user interface to modify the welding sequence by modifying one or more properties or parameters associated with a functional weld sequence step.

Details of illustrated embodiments of the present invention will be more fully understood from the following description and drawings.

### BRIEF DESCRIPTION OF THE DRAWINGS

FIG. 1 illustrates a welding operation of the related art utilizing a semi-automatic welding work cell;

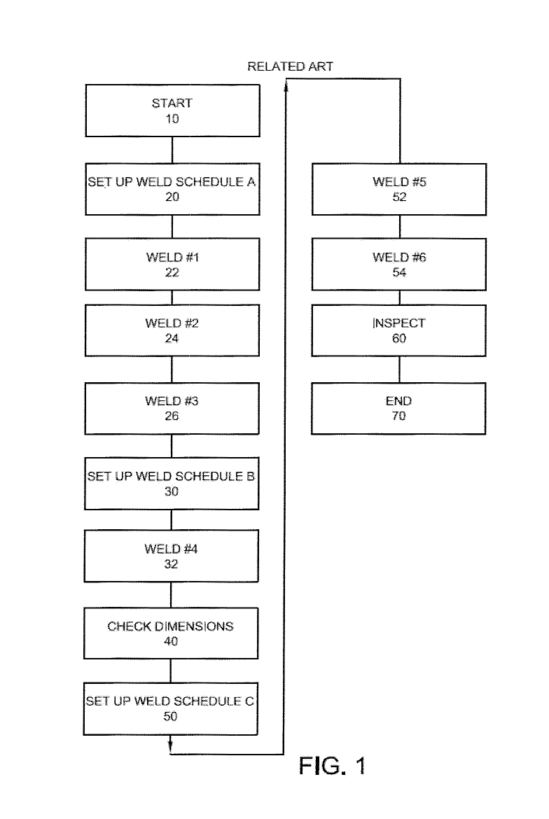

FIG. 2 illustrates a welding operation according to the invention utilizing a semi-automatic welding work cell;

FIG. 3 is a block diagram illustrating a welding system that utilizes a welding job sequencer component to configure welding equipment for two or more weld operations to assembly a workpiece;

FIG. 4 is a block diagram illustrating a welding system that utilizes a welding job sequencer component;

FIG. 5 is a block diagram illustrating a distributed welding environment with a plurality of welding work cells that interface with a welding job sequencer component via a local, remote, or cloud database;

FIG. 6 is a block diagram illustrating a welding system that includes a plurality of welding work cells in which welding work cells are managed by a cloud-based welding job sequencer component;

FIG. 7 is a block diagram illustrating an embodiment of a personal computer (e.g., a tablet device) having a weld sequence editor (WSE) software application installed thereon;

FIG. 8 illustrates an embodiment of a system for performing an assembly operation on a part using a welding sequence generated by a user of the personal computer of FIG. 7 using the WSE software application;

FIG. 9 illustrates an example embodiment of a flow chart display screen provided by the weld sequence editor of FIG. 7;

FIG. 10 illustrates an example embodiment of a serial number window provided by the weld sequence editor of FIG. 7;

FIG. 11 illustrates an example embodiment of a serial number display screen provided by the welding job sequence component of FIG. 8;

FIG. 12 illustrates an example embodiment of a wire weight window provided by the weld sequence editor of FIG. 7;

FIG. 13 illustrates an example embodiment of a consumable weight display screen provided by the welding job sequence component of FIG. 8;

FIG. 14 illustrates an example embodiment of a tack weld properties window provided by the weld sequence editor of FIG. 7;

FIG. 15 illustrates an example embodiment of a tack weld display screen provided by the welding job sequence component of FIG. 8;

FIG. 16 illustrates an example embodiment of a base weld properties window provided by the weld sequence editor of FIG. 7;

FIG. 17 illustrates an example embodiment of a base weld validations window provided by the weld sequence editor of FIG. 7;

FIG. 18 illustrates an example embodiment of a base weld heads window provided by the weld sequence editor of FIG. 7;

FIG. 19 illustrates an example embodiment of an base weld parameters window provided by the weld sequence editor of FIG. 7; and

FIG. 20 illustrates an example embodiment of an alert window provided by the weld sequence editor of FIG. 7.

### DETAILED DESCRIPTION

Embodiments of the present invention provide systems and methods for generating and editing a welding sequence to be used by a welding job sequencer. Systems and methods to help a user generate a weld sequence are provided. A weld sequence editor allows a user to create a flow chart of functions for completing a set of work instructions and allows the user to organize the functions into logical groups of steps. The logical groups of steps may be numbered, named, and the first function of each group may be identified. When a weld sequence is executed, each logical group is a defined, visible step to an operator. The logical groups are used to organize information and progress through a set of work instructions while multiple background functions execute without complicating the operator's view of the work flow. The weld sequence editor provides a method to organize the same work instructions into a detailed viewpoint for a user of the editor, and a summarized viewpoint for the operator of a work cell.

Initially, embodiments using a welding job sequencer are described herein to put in context the idea of performing welding operations using a welding sequence. Subsequently, a weld sequence editor (WSE) is described herein in the context of generating a welding sequence that is to be used by a welding job sequencer.

### Welding Job Sequencer

The term “component” as used herein can be defined as a portion of hardware, a portion of software, or a combination thereof. A portion of hardware can include at least a processor and a portion of memory, wherein the memory includes an instruction to execute.

The term “welding”, and its derivative forms, as used herein may refer to any of arc welding, laser welding, brazing, soldering, plasma cutting, waterjet cutting, laser cutting, and any other systems and methods using similar control methodology, without departing from the spirit and scope of the material discussed herein.

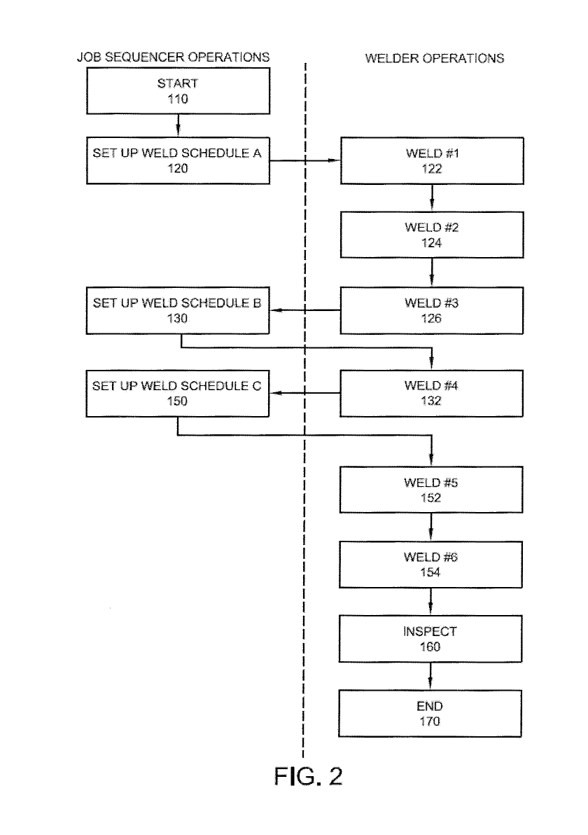

The examples and figures herein are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIG. 2 is referenced. In an exemplary embodiment of the invention as illustrated in FIG. 2, a welding job sequencer is provided. The welding job sequencer improves the semi-automatic work cell of the related art by increasing the productivity of the semi-automatic work cell without compromising the number of weld schedules usable therein. The welding job sequencer accomplishes this improvement by implementing automatic changes in the semi-automatic work cell, and by providing the operator with an array of commands and instructions.

More specifically, in an exemplary embodiment, the welding job sequencer automatically selects and implements a function of the welding work cell. An example of such a function includes a particular weld schedule to be used with the semi-automatic work cell. In other words, the welding job sequencer may select a weld schedule to be used for a particular weld, and modify the settings of the semi-automatic work cell in accordance with the selected weld schedule, automatically for the operator (i.e., without the operator's specific intervention).

Additionally, in the exemplary embodiment, the welding job sequencer may automatically indicate a sequence of operations that the operator should follow to create a final welded assembly. In conjunction with the automatic selection of welding schedules, this indicated sequence allows an operator to follow the sequence to create a final welded part, without having to spend time adjusting, selecting, or reviewing each individual weld schedule and/or sequence.

Accordingly, since the welding job sequencer sets up the welding equipment and organizes the workflow, and since the operator only performs the welding operations themselves, the chance for error in the welding operation is greatly reduced, and productivity and quality are improved.

The exemplary embodiment is diagrammatically represented in FIG. 2. In FIG. 2, at operation 110, the welding job sequencer begins operation, and immediately sets the welding equipment to use weld schedule A (operation 120) and instructs the operator to perform welds #1, #2 and #3. Then, the operator performs welds #1, #2 and #3 using weld schedule A (operations 122, 124 and 126). Next, the welding job sequencer sets the welding equipment to use weld schedule B (operation 130), and instructs the operator to perform weld #4. Then the operator performs weld #4 using weld schedule B (operations 132). After completion of weld schedule B, the welding job sequencer sets the welding equipment to use weld schedule C (operation 150), and instructs the operator to perform welds #5 and #6, and to inspect the part. Then, the operator performs welds #5 and #6 (operations 152, and 154) using weld schedule C, and inspects the completed part to confirm that it is correct (operation 160). This inspection may include dimensional verification, visual defect confirmation, or any other type of check that might be needed. Further, operation 160 may include a requirement that the operator affirmatively indicate that the inspection is complete, such as by pressing an “OK” button, before it is possible to proceed to the next operation. Lastly, the welding job sequencer indicates that the welding operation is at an end (operation 170), and re-sets for the next operation.

Accordingly, as noted above, the sequencing and scheduling of welding operations is completed by the sequencer, and frees the operator to focus on performing welds according to instruction.

The welding job sequencer may select and implement a new function, such as the selection and implementation of weld schedules A, B and C shown in FIG. 2, based upon various variables or inputs. For example, the welding job sequencer may simply select new weld schedules based upon a monitoring of elapsed time since the beginning of the welding operations, or since the cessation of welding (such as the time after weld #3 in FIG. 2 above). Alternatively, the welding job sequencer may monitor the actions of the operator, compare the actions to the identified sequence of welds, and select new weld schedules appropriately. Still further, various combinations of these methods, or any other effective method, may be implemented, as long as the end effect is to provide an automatic selection and implementation of a function, such as the weld schedule, for use by the operator.

Parameters of the selected weld schedule may include such variables as welding process, wire type, wire size, WFS, volts, trim, which wire feeder to use, or which feed head to use, but are not limited thereto.

While the above description focuses on the selection of a weld schedule as a function which is automatically selected and implemented, the welding job sequencer is not limited to using only this function.

For example, another possible function that may be selected and implemented by the welding job sequencer is a selection of one of multiple wire feeders on a single power source in accordance with the weld schedule. This function provides an even greater variability in welding jobs capable of being performed by the operator in the semi-automatic work cell, since different wire feeders can provide a great variance of, for example, wire sizes and types.

Another example of a function compatible with the welding job sequencer is a Quality Check function. This function performs a quality check of the weld (either during welding or after the weld is completed) before allowing the job sequence to continue. The quality check can monitor various welding parameters and can pause the welding operation and alert the operator if an abnormality is detected. An example of a welding parameter measurable by this function would be arc data.

Another example of such a function would be a Repeat function. This function would instruct the operator to repeat a particular weld or weld sequence. An example of the use of this function includes when the Quality Check function shows an abnormality, or when multiple instances of the same weld are required.

Another example of such a function would be a Notify Welder function, which communicates information to the welder. This function would display information, give an audible signal, or communicate with the welder by some other means. Examples of use of this function include an indication to the operator that he is free to begin welding, or an indication that the operator should check some portion of the welded part for quality purposes.

Another example of such a function would be a Enter Job Information function. This function will require the welder to enter information, such as the part serial number, a personal ID number, or other special conditions before the job sequencer can continue. This information could also be read from a part or inventory tag itself through Radio Frequency Identification (RFID), bar code scanning, or the like. The welding job sequencer could then utilize the entered information for the welding operations. An example of the use of this function would be as a predicate to the entire welding operation, so as to indicate to the welding job sequencer which schedules and/or sequences should be selected.

A further example of such a function would be a Job Report function. This function will create a report on the welding job, which could include information such as: the number of welds performed, total and individual arc timing, sequence interruptions, errors, faults, wire usage, arc data, and the like. An example of the use of this function would be to report to a manufacturing quality department on the efficiency and quality of the welding processes.

A still further example of such a function would be a System Check function. This function will establish whether the welding job can continue, and could monitor such parameters as: wire supply, gas supply, time left in the shift (as compared to the required time to finish the job), and the like. The function could then determine whether the parameters indicate that there is enough time and/or material for the welding job to continue. This function would prevent down-time due to material depletion, and would prevent work-in-process assemblies from being delayed, which can lead to quality problems due to thermal and scheduling issues.

Further, as mentioned above, the welding job sequencer may select and implement a new function, based upon various variables or inputs. These variables and inputs are not particularly limited, and can even be another function. For example, another function compatible with the welding job sequencer is a Perform Welding Operation function. This function is designed to detect the actual welding performed by the operator, and to report that welding so that the welding job sequencer can determine whether to proceed with further operations. For example, this function can operate by starting when the operator pulls the trigger to start the welding operation, and finishing when the operator releases the trigger after the welding is complete, or after a predetermined period of time after it starts. This function could end when the trigger is released or it could be configured to automatically turn off after a period of time, a quantity of wire, or an amount of energy is delivered. This function may be used to determine when to select a new function, such as a new weld schedule, as discussed above.

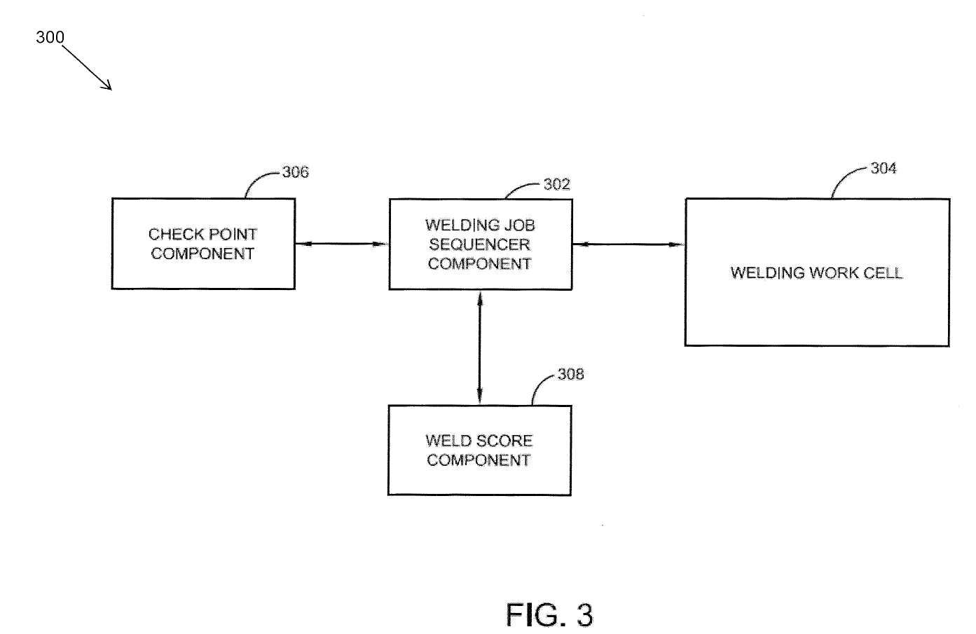

FIG. 3 is a schematic block diagram of an exemplary embodiment of welding system 300 that utilizes welding job sequencer component 302 (also referred to as welding job sequencer) to configure welding equipment for two or more weld operations to assemble a workpiece. Welding job sequencer component 302 is configured to implement a welding sequence that includes settings, configurations, and/or parameters to perform two or more welding procedures on a workpiece. In particular, welding job sequencer component 302, as discussed above as welding job sequencer, automatically configures welding equipment to create two or more welds that include two or more welding schedules. Moreover, welding job sequencer component 302 utilizes the welding sequence to aid an operator to perform the two or more welds. As discussed above, welding job sequencer component 302 can be utilized with welding work cell 304 that is semi-automatic. However, it is to be appreciated and understood that welding job sequencer component 302 can be implemented in a suitable welding environment or system that includes at least welding equipment and an operator to facilitate creating one or more welds.

Welding system 300 further includes check point component 306 that is configured to monitor a welding process and/or a welding operator in real time. For instance, the welding process is monitored in real time to detect at least one of a welding parameter (e.g., voltage, current, among others), a welding schedule parameter (e.g., welding process, wire type, wire size, WFS, volts, trim, wire feeder to use, feed head to use, among others), a weld on a workpiece as the weld is created, a movement of an operator, a position of a welding tool, a position or location of a welding equipment, a position or location of an operator, sensor data (e.g., video camera, image capture, thermal imaging device, heat sensing camera, temperature sensor, among others), and the like. Check point component 306 includes an alert system (not shown) that can communicate an alert or notification to indicate a status of the real time monitoring. In an embodiment, check point component 306 can utilize thresholds, ranges, limits, and the like for the real time monitoring to precisely identify a abnormality with welding system 300. Furthermore, check point component 306 can communicate an alert or notification to welding work cell 304 or the operator to at least one of stop the welding procedure, continue with the welding procedure, pause the welding procedure, terminate the welding procedure, or request approval of the welding procedure. In an embodiment, check point component 306 can store monitoring data (e.g., video, images, results, sensor data, and the like) in at least one of a server, a data store, a cloud, a combination thereof, among others.

Weld score component 308 is included with welding system 300 and is configured to evaluate a weld created by an operator within welding work cell 304 upon completion of such weld. Weld score component 308 provides a rating or score for the completed weld to facilitate implementing a quality control on the workpiece and/or assembly of the workpiece. For instance, weld score component 308 can alert a quality inspection upon completion, provide data collection of a job (e.g., assembly of workpiece, weld on workpiece, among others), and the like. In an embodiment, an in-person quality inspection can be performed upon completion of a portion of the assembly (e.g., completion of a weld, completion of two or more welds, completion of assembly, among others). In another embodiment, weld score component 308 can utilize a sensor to collect data (e.g., video camera, image capture, thermal imaging device, heat sensing camera, temperature sensor, among others) to determine approval of the job. For instance, a quality inspection can be performed remotely via video or image data collected upon completion of a job.

It is to be appreciated that welding job sequencer component 302 can be a stand-alone component (as depicted), incorporated into welding work cell 304, incorporated into check point component 306, incorporated into weld score component 308, or a suitable combination thereof. Additionally, as discussed below, welding job sequencer component 302 can be a distributed system, software-as-a-service (SaaS), a cloud-based system, or a combination thereof. Further, it is to be appreciated and understood that check point component 306 can be a stand-alone component (as depicted), incorporated into welding work cell 304, incorporated into welding job sequencer component 302, incorporated into weld score component 308, or a suitable combination thereof. Additionally, check point component 306 can be a distributed system, software-as-a-service (SaaS), a cloud-based system, or a combination thereof. Moreover, it is to be appreciated and understood that weld score component 308 can be a stand-alone component (as depicted), incorporated into welding work cell 304, incorporated into welding job sequencer component 302, incorporated into check point component 306, or a suitable combination thereof. Additionally, weld score component 308 can be a distributed system, software-as-a-service (SaaS), a cloud-based system, or a combination thereof.

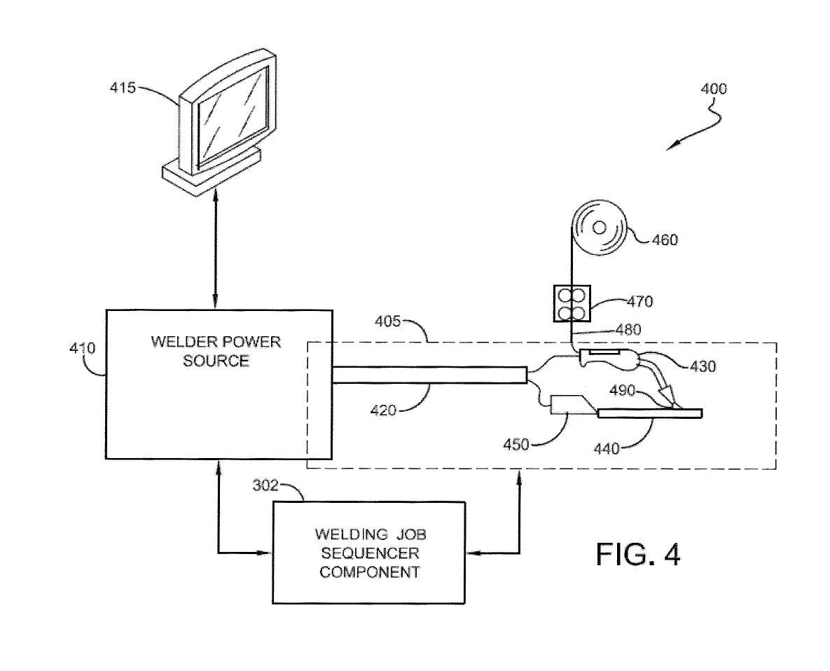

FIG. 4 illustrates a schematic block diagram of an exemplary embodiment of welding system 400 including welding circuit path 405. It is to be appreciated that welding system 400 is also referred to as the welding work cell, wherein the welding work cell and/or welding system 400 can produce welds or welded parts. Welding system 400 includes welder power source 410 and display 415 operationally connected to welder power source 410. Alternatively, display 415 may be an integral part of welder power source 410. For instance, display 415 can be incorporated into welder power source 410, a stand-alone component (as depicted), or a combination thereof. Welding system 100 further includes welding cable 120, welding tool 430, workpiece connector 450, spool of wire 460, wire feeder 470, wire 480, and workpiece 440. Wire 480 is fed into welding tool 430 from spool 460 via wire feeder 470, in accordance with an embodiment of the present invention. In accordance with another embodiment of the present invention, welding system 400 does not include spool of wire 460, wire feeder 470, or wire 480 but, instead, includes a welding tool comprising a consumable electrode such as used in, for example, stick welding. In accordance with various embodiments of the present invention, welding tool 430 may include at least one of a welding torch, a welding gun, and a welding consumable.

Welding circuit path 405 runs from welder power source 410 through welding cable 420 to welding tool 430, through workpiece 440 and/or to workpiece connector 450, and back through welding cable 420 to welder power source 110. During operation, electrical current runs through welding circuit path 405 as a voltage is applied to welding circuit path 405. In accordance with an exemplary embodiment, welding cable 420 comprises a coaxial cable assembly. In accordance with another embodiment, welding cable 420 comprises a first cable length running from welder power source 410 to welding tool 430, and a second cable length running from workpiece connector 450 to welder power source 410.

Welding system 400 includes welding job sequencer component 302 (as described above). Welding job sequencer component 302 is configured to interact with a portion of welding system 400. For instance, welding job sequencer component 302 can interact with at least the power source 410, a portion of welding circuit path 405, spool of wire 460, wire feeder 470, or a combination thereof. Welding job sequencer component 302 automatically adjusts one or more elements of welding system 400 based on a welding sequence, wherein the welding sequence is utilized to configure welding system 400 (or an element thereof) without operator intervention in order to perform two or more welding procedures with respective settings or configurations for each welding procedure.

In an embodiment, welding job sequencer component 302 employs a welding sequence to automatically configure welding equipment. It is to be appreciated that welding system 400 or a welding work cell can employ a plurality of welding sequences for assembly of one or more workpieces. For instance, a workpiece can include three (3) welds to complete assembly in which a first welding sequence can be used for the first weld, a second welding sequence can be used for the second weld, and a third welding sequence can be used for the third weld. Moreover, in such example, the entire assembly of the workpiece including the three (3) welds can be referenced as a welding sequence. In an embodiment, a welding sequence that includes specific configurations or steps can further be included within a disparate welding sequence (e.g., nested welding sequence). A nested welding sequence can be a welding sequence that includes a welding sequence as part of the procedure. Moreover, the welding sequence can include at least one of a parameter, a welding schedule, a portion of a welding schedule, a step-by-step instruction, a portion of media (e.g., images, video, text, and the like), a tutorial, among others. In general, the welding sequence can be created and employed in order to guide an operator through welding procedure(s) for specific workpieces without the operator manually setting welding equipment to perform such welding procedures. The subject innovation relates to creating a welding sequence and/or modifying a welding sequence.

One or more welder power source(s) (e.g., welder power source 410) aggregates data respective to a respective welding process to which the welder power source is providing power to implement. Such collected data relates to each welder power source and is herein referred to as “weld data.” Weld data can include welding parameters and/or information specific to the particular welding process to which the welder power source is supplying power. For instance, weld data can be an output (e.g., a waveform, a signature, a voltage, a current, among others), a weld time, a power consumption, a welding parameter for a welding process, a welder power source output for the welding process, and the like. In an embodiment, weld data can be utilized with welding job sequencer component 302. For example, weld data can be set by a welding sequence. In another example, weld data can be used as a feedback or a feedforward loop to verify settings.

In one embodiment, welding job sequencer component 302 is a computer operable component to execute the methodologies and processes disclosed herein. In order to provide additional context for various aspects of embodiments of the present invention, the following discussion is intended to provide a brief, general description of a suitable computing environment in which the various aspects of embodiments of the present invention may be implemented. While embodiments have been described above in the general context of computer-executable instructions that may run on one or more computers, those skilled in the art will recognize that embodiments also may be implemented in combination with other program modules and/or as a combination of hardware and/or software. Generally, program modules include routines, programs, components, data structures, etc., that perform particular tasks or implement particular abstract data types.

Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like, each of which may be operatively coupled to one or more associated devices. The illustrated aspects of the invention may also be practiced in distributed computing environments where certain tasks are performed by remote processing devices that are linked through a communications network. In a distributed computing environment, program modules may be located in both local and remote memory storage devices. For instance, a remote database, a local database, a cloud-computing platform, a cloud database, or a combination thereof can be utilized with welding job sequencer 302.

Welding job sequencer 302 can utilize an exemplary environment for implementing various aspects of the invention including a computer, wherein the computer includes a processing unit, a system memory and a system bus. The system bus couples system components including, but not limited to the system memory to the processing unit. The processing unit may be any of various commercially available processors. Dual microprocessors and other multi-processor architectures also can be employed as the processing unit.

The system bus can be any of several types of bus structure including a memory bus or memory controller, a peripheral bus and a local bus using any of a variety of commercially available bus architectures. The system memory can include read only memory (ROM) and random access memory (RAM). A basic input/output system (BIOS), containing the basic routines that help to transfer information between elements within welding job sequencer 302, such as during start-up, is stored in the ROM.

Welding job sequencer 302 can further include a hard disk drive, a magnetic disk drive, e.g., to read from or write to a removable disk, and an optical disk drive, e.g., for reading a CD-ROM disk or to read from or write to other optical media. Welding job sequencer 302 can include at least some form of computer readable media. Computer readable media can be any available media that can be accessed by the computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other magnetic storage devices, or any other medium which can be used to store the desired information and which can be accessed by welding job sequencer 302.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, Radio Frequency (RF), Near Field Communications (NFC), Radio Frequency Identification (RFID), infrared, and/or other wireless media. Combinations of any of the above should also be included within the scope of computer readable media.

A number of program modules may be stored in the drives and RAM, including an operating system, one or more application programs, other program modules, and program data. The operating system in welding job sequencer 302 can be any of a number of commercially available operating systems.

In addition, a user may enter commands and information into the computer through a keyboard and a pointing device, such as a mouse. Other input devices may include a microphone, an IR remote control, a track ball, a pen input device, a joystick, a game pad, a digitizing tablet, a satellite dish, a scanner, or the like. These and other input devices are often connected to the processing unit through a serial port interface that is coupled to the system bus, but may be connected by other interfaces, such as a parallel port, a game port, a universal serial bus (“USB”), an IR interface, and/or various wireless technologies. A monitor (e.g., display 415), or other type of display device, may also be connected to the system bus via an interface, such as a video adapter. Visual output may also be accomplished through a remote display network protocol such as Remote Desktop Protocol, VNC, X-Window System, etc. In addition to visual output, a computer typically includes other peripheral output devices, such as speakers, printers, etc.

A display (in addition or in combination with display 415) can be employed with welding job sequencer 302 to present data that is electronically received from the processing unit. For example, the display can be an LCD, plasma, CRT, etc. monitor that presents data electronically. Alternatively or in addition, the display can present received data in a hard copy format such as a printer, facsimile, plotter etc. The display can present data in any color and can receive data from welding job sequencer 302 via any wireless or hard wire protocol and/or standard. In another example, welding job sequencer 302 and/or system 400 can be utilized with a mobile device such as a cellular phone, a smart phone, a tablet, a portable gaming device, a portable Internet browsing device, a Wi-Fi device, a Portable Digital Assistant (PDA), among others.

The computer can operate in a networked environment using logical and/or physical connections to one or more remote computers, such as a remote computer(s). The remote computer(s) can be a workstation, a server computer, a router, a personal computer, microprocessor based entertainment appliance, a peer device or other common network node, and typically includes many or all of the elements described relative to the computer. The logical connections depicted include a local area network (LAN) and a wide area network (WAN). Such networking environments are commonplace in offices, enterprise-wide computer networks, intranets and the Internet.

When used in a LAN networking environment, the computer is connected to the local network through a network interface or adapter. When used in a WAN networking environment, the computer typically includes a modem, or is connected to a communications server on the LAN, or has other means for establishing communications over the WAN, such as the Internet. In a networked environment, program modules depicted relative to the computer, or portions thereof, may be stored in the remote memory storage device. It will be appreciated that network connections described herein are exemplary and other means of establishing a communications link between the computers may be used.

Alternatively or in addition, a local or cloud (e.g., local, cloud, remote, among others) computing platform can be utilized for data aggregation, processing, and delivery. For this purpose, the cloud computing platform can include a plurality of processors, memory, and servers in a particular remote location. Under a software-as-a-service (SaaS) paradigm, a single application is employed by a plurality of users to access data resident in the cloud. In this manner, processing requirements at a local level are mitigated as data processing is generally done in the cloud, thereby relieving user network resources. The software-as-a-service application allows users to log into a web-based service (e.g., via a web browser) which hosts all the programs resident in the cloud.

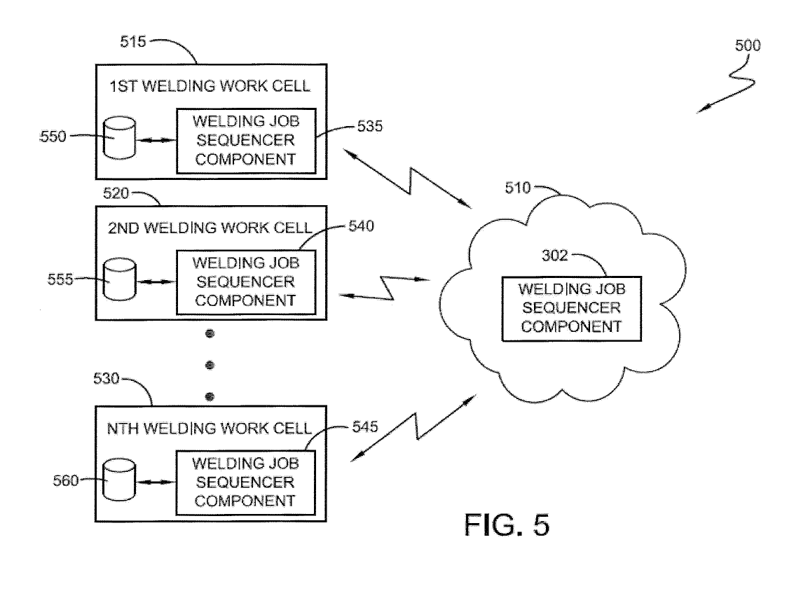

Turning to FIG. 5, system 500 illustrates a welding environment with a plurality of welding work cells via a local, remote, or cloud database. System 500 includes a plurality of welding work cells such as first welding work cell 515, second welding work cell 520 to Nth welding work cell 530, where N is a positive integer. In an embodiment, each welding work cell includes a welding job sequencer component 535, 540, and 545, that is used to implement a welding schedule(s) to each welding work cell as well as or in the alternative to an enterprise-wide welding operation(s) and/or enterprise-wide welding work cell. Welding sequence(s) from each welding job sequencer component 535, 540, and 545 is received from the local or cloud database (e.g., local database, cloud database, remote database, among others) computing platform 510.

In an embodiment, each welding work cell further includes a local data store. For instance, first welding work cell 515 includes welding job sequencer component 535 and data store 550, second welding work cell 520 includes welding job sequencer component 540 and data store 555, and Nth welding work cell 530 includes welding job sequencer component 545 and data store 560. It is to be appreciated that system 500 includes welding job sequencer 302 hosted by computing platform 510 in which each welding work cell includes a distributed and respective welding job sequencer component. Yet, it is to be understood that welding job sequencer 302 (and distributed welding job sequencer components 535, 540, and 545) can be a stand-alone component in each welding work cell or a stand-alone component in the computing platform 510.

Each welding work cell can include a respective data store that stores a portion of at least one welding sequence. For instance, welding sequences related to a welding process A is employed at one or more welding work cell. The welding sequence is stored in a respective local data store (e.g., data stores 550, 555, and 560). Yet, it is to be appreciated and understood that each welding work cell can include a local data store (as depicted), a collective and shared remote data store, a collective and shared local data store, a cloud data store hosted by computing platform 510, or a combination thereof. A “data store” or “memory” can be, for example, either volatile memory or nonvolatile memory, or can include both volatile and nonvolatile memory. The data store of the subject systems and methods is intended to comprise, without being limited to, these and other suitable types of memory. In addition, the data store can be a server, a database, a hard drive, a flash drive, an external hard drive, a portable hard drive, a cloud-based storage, a solid-state drive, and the like.

For instance, welding job sequencer component 302 can manage each welding job sequencer component 535, 540, 545 in each welding work cell 515, 520, 530. In another embodiment, the communications can be transmitted from the welding job sequencer 302 to each welding work cell (e.g., each welding job sequencer component). In another embodiment, the communications can be received from each welding work cell (e.g., each welding job sequencer component) from the welding job sequencer component 302. For instance, a welding sequence can be used with 1^{st} welding work cell 515 and communicated directly to a disparate welding work cell or via computing platform 510.

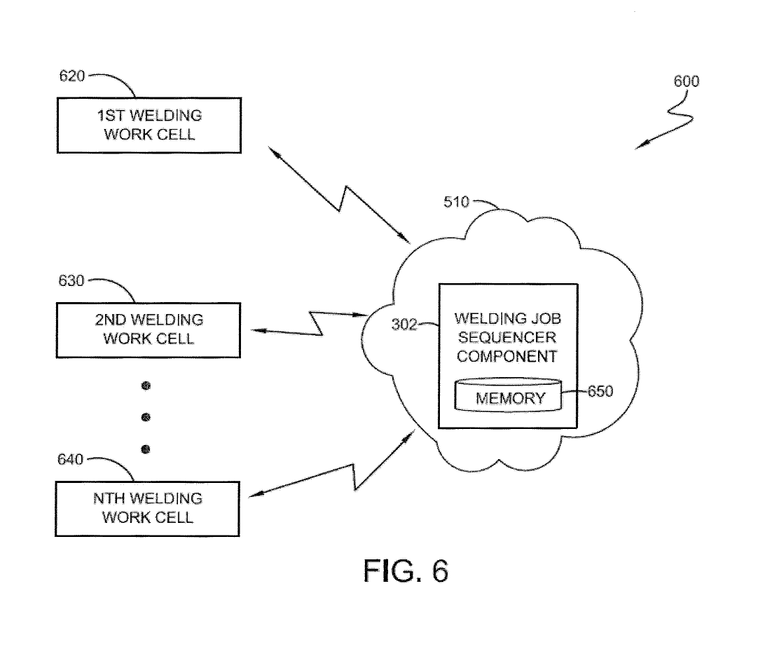

FIG. 6 illustrates welding system 600 that includes a plurality of welding work cells in which welding job sequencer component 302 is hosted with computing platform 510 to utilize one or more welding sequences to configure welding equipment within one or more welding systems, welding environments, and/or welding work cells. Welding system 600 includes a local or cloud-based welding job sequencer component 302 hosted in computing platform 510. Welding job sequencer component 302 can utilize a welding sequence with a number of welding work cell. For instance, welding system 600 can a number of welding work cells such as, but not limited to, 1^{st} welding work cell 620, 2^{nd} welding work cell 630, to Nth welding work cell, where N is a positive integer. It is to be appreciated that the locality of the welding job sequencer component 302 is in relation to each 1^{st} welding work cell 620, 2^{nd} welding work cell 630, and/or Nth welding work cell 640.

In an embodiment, welding job sequencer 302 communicates one or more welding sequence to a target welding work cell, wherein the target welding work cell is a welding work cell that is to utilize the communicated welding sequence. Yet, in another embodiment, welding job sequencer 302 utilizes memory 650 hosted by computing platform 510 in which one or more welding sequences are stored. Yet, the stored welding sequence can be related or targeted to one or more welding work cells regardless of a storage location (e.g., local, cloud, remote, among others).

### Weld Sequence Editor

As described above herein, a welding job sequencer may use welding sequences to aid an operator in assembling a part requiring multiple welds. A welding sequence can have many steps that have to be performed to assemble a part. The welding sequence can be very detailed and difficult to generate. Furthermore, there may be many functional steps in a welding sequence that are not necessary for an operator to see or even know about, lest those steps unnecessarily complicate the operator's task with respect to assembling the part.

Therefore, in accordance with an embodiment, a weld sequence editor (WSE) (a.k.a., the editor) is provided to make it easier and more efficient for a user to generate a welding sequence. The weld sequence editor is a programming tool in the form of a software application (having computer-executable instructions) that runs on, for example, a Windows™-based computer (or other type of computer) and provides a graphical user interface (GUI) that allows a user to readily construct a detailed welding sequence for a part to be assembled. A resulting welding sequence out of the editor is in the form of an electronic file (e.g., a XML type file) that can be read and executed by the welding job sequencer during an assembly operation.

In accordance with an embodiment, the weld sequence editor allows a user to create groups of detailed steps in a flow charting manner using graphical icons that each represent a detailed step (functional weld sequence step) in a group (functional weld sequence group). A user of the editor selects and defines the detailed steps. Each group of detailed steps represents an operator-level step that the operator experiences when using the welding job sequencer with the resulting weld sequence from the editor to assemble a part. Many of the detailed steps in a group, however, may be transparent to the operator. During an assembly operation, the operator advances through the groups of steps, not each detailed step in a group. Therefore, the operator is able to focus on the task of welding and not on other extraneous detailed steps such as, for example, setting up a welding power source for a next weld to be made.

In one embodiment, a weld sequence editor is provided. The weld sequence editor includes a computer having at least one processor, a computer memory, and a display device. The weld sequence editor further includes a weld sequence editor software application stored on the computer memory including computer-executable instructions configured to be executed by the at least one processor. The weld sequence editor software application is configured to provide a graphical user interface having a tool bar section, a function selection section, and a programmable flowchart section. The programmable flowchart section is configured to provide a space for a user to generate a welding sequence for assembling a part by defining functional weld sequence groups, programming one or more functional weld sequence steps for each of the functional weld sequence groups, and programming the functional flow through the functional weld sequence groups. The weld sequence editor software application may be configured to generate an electronic welding sequence file having the welding sequence generated by the user. The computer may include a communication device configured to output the welding sequence file for use by a welding job sequencer. The communication device may be configured as a wireless communication device. The computer may be configured as one or more of a tablet computer, a desktop computer, a hand-held mobile device, or a workstation. The display device may be a touch-screen display device configured to facilitate use of the graphical user interface. The weld sequence editor may include a user input device providing one or more of a computer keyboard and a computer mouse to facilitate use of the graphical user interface.

In one embodiment, a welding system is provided. The welding system includes the weld sequence editor as described above herein. The welding system also includes a welding job sequencer configured to implement a welding sequence, and a welding work cell having a welding power source configured to be used by an operator to produce one or more welded parts in accordance with the welding sequence. The welding system may include a display device operatively connected to the welding job sequencer. The display device may be a touch-screen (touch-sensitive) display device providing user input capability. The welding work cell may include one or more of a wire feeder, a welding cable, a welding tool, consumable welding wire, a consumable welding electrode, a non-consumable welding electrode, a workpiece connector, and one or more workpiece parts to be welded. The welding job sequencer may be configured to interact with one or more of the welding power source, the wire feeder, or the welding tool when implementing the welding sequence. The welding sequence editor may include one or more of a tablet computer, a desktop computer, a hand-held mobile device, or a workstation. The welding system may include a user input device providing one or more of a computer keyboard and a computer mouse to facilitate use of the welding job sequencer by an operator.

In one embodiment, a method of generating a welding sequence is provided. The method includes defining functional weld sequence groups in a programmable flowchart section of a graphical user interface provided by a weld sequence editor software application running on a computer. The method also includes selecting functional icons, representative of functional weld sequence steps, from a function selection section of the graphical user interface and populating the functional weld sequence groups with the selected functional icons in the programmable flowchart section. The method further includes linking the functional icons and the functional weld sequence groups in the programmable flowchart section to program a functional flow through the functional weld sequence groups of functional weld sequence steps, resulting in a welding sequence. The method may further include exporting the welding sequence to an electronic file using a tool bar section of the graphical user interface, where the electronic file is stored in an electronic memory of the computer. The method may also include wirelessly transmitting the electronic file from the computer to a welding job sequencer component. The method may further include using the graphical user interface to modify the welding sequence by one or more of deleting a functional weld sequence step from a functional weld sequence group or adding a functional weld sequence step to a functional weld sequence group. The method may also include using the graphical user interface to modify the welding sequence by modifying one or more properties or parameters associated with a functional weld sequence step.

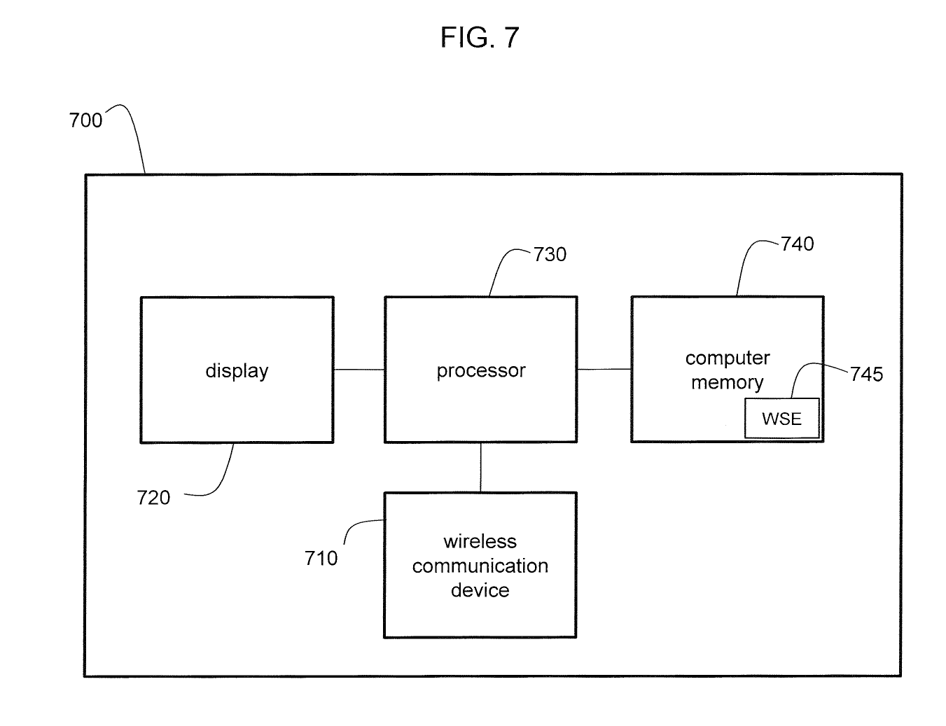

FIG. 7 is a block diagram illustrating an embodiment of a personal computer 700 (e.g., a tablet device) having a weld sequence editor (WSE) software application 745 installed thereon. The tablet device 700 may be used by a user to generate a welding sequence. The tablet device 700 includes a display device, wireless and/or wired communication means, and computer memory storing at least the weld sequence editor (WSE) software application 745 (a.k.a., the editor). The tablet device 700 also includes processing means operable to execute coded instructions of the WSE 745. The personal computer 700 may include other hardware and software components and elements as well, as are known to those skilled in the art. In accordance with various embodiments, the personal computer may instead be in the form of one or more of a tablet computer, a desktop computer, a hand-held mobile device, or a computer workstation, for example.

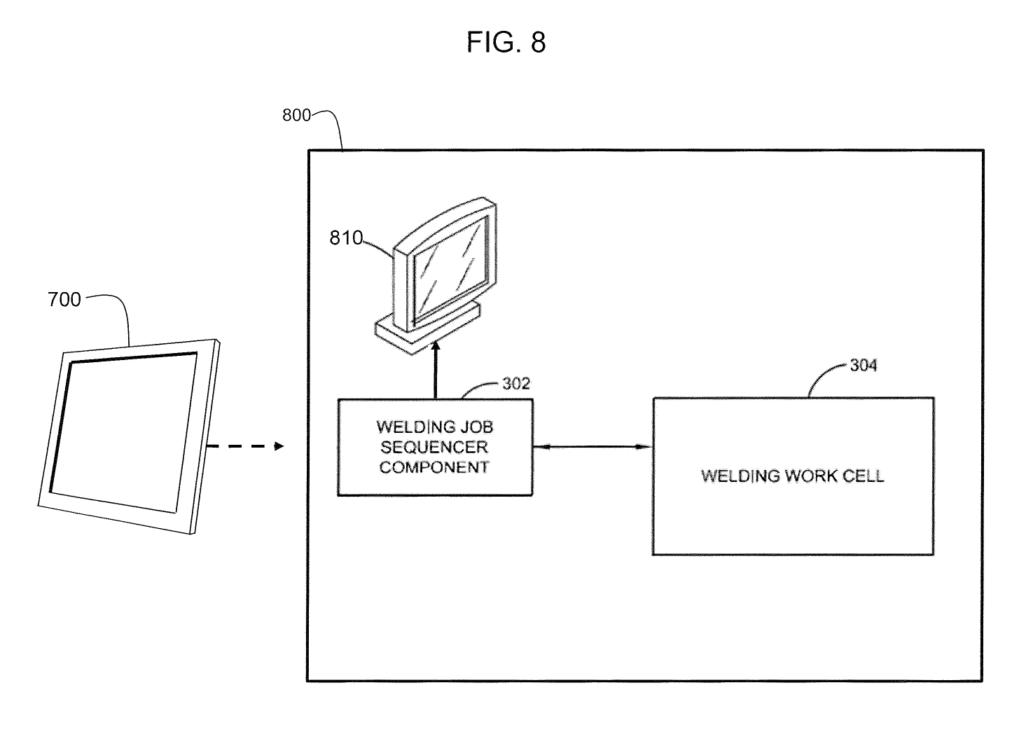

FIG. 8 illustrates an embodiment of a system 800 for performing an assembly operation on a part using a welding sequence generated by a user of the tablet computer 700 using the WSE software application 745. The system 800 includes a welding job sequencer component 302 and a welding work cell 304 as described previously herein. The welding work cell may include, for example, one or more of a welding power source, a wire feeder, a welding cable, a welding tool, consumable welding wire, a consumable welding electrode, a non-consumable welding electrode, a workpiece connector, and one or more workpiece parts to be welded. The welding job sequencer may be configured to interact with one or more of the welding power source, the wire feeder, or the welding tool when implementing a welding sequence. A user input device providing one or more of a computer keyboard or computer mouse may be provided to facilitate use of the welding job sequencer.

The system 800 further includes a display device 810 operatively connected to the welding job sequencer component 302. In this manner, an operator of the system 800 can view display screens of steps associated with the welding sequence on the display device 810 to perform the assembly operation. The display device 810 may also serve as an input device (e.g., having a touch-screen) that allows a user to input information to the system 800 (e.g., in response to one or more steps of the welding sequence). In accordance with other embodiments, the display device may be a part of the welding job sequencer component or the welding work cell.

Referring again to FIG. 7, the tablet device 700 includes a wireless communication device 710. The wireless communication device may include, for example, WiFi communication circuitry and software and/or 3G or 4G communication circuitry and software providing access to the system 800 having the welding job sequencer component 302, and/or to an external communication infrastructure (e.g., a network or the internet). The tablet device 700 also includes a display 720, a processor 730, and computer memory 740. The display 720 may be a touch-screen (touch-sensitive) display, in accordance with an embodiment. The processor 730 may be a programmable microprocessor, for example, although other types of logic processors are possible as well. The computer memory 740 may be, for example, electronic memory, such as a combination of random access memory (RAM) and read-only memory (ROM). Other types of computer memory may be possible as well, in accordance with various other embodiments. In accordance with an embodiment, a user input device such as, for example, a computer keyboard or a computer mouse, may be provided to facilitate use of the graphical user interface of the weld sequence editor. The personal computer 700 may include other hardware and software components as well, as are known to those skilled in the art.

The computer memory 740 stores at least the weld sequence editor (WSE) software application 745 having coded instructions that may be executed on the processor 730 to allow a user to generate a welding sequence for welding a part to be assembled. In accordance with an embodiment, the system 800 may be accessed via the wireless communication device 710 of the tablet device 700 to download a weld sequence file (WSF), having the generated welding sequence, to be read and used by the welding job sequencer component 302 during an assembly operation. Alternatively, the tablet device 700 may store the WSF on a network which can be accessed by the system 800.

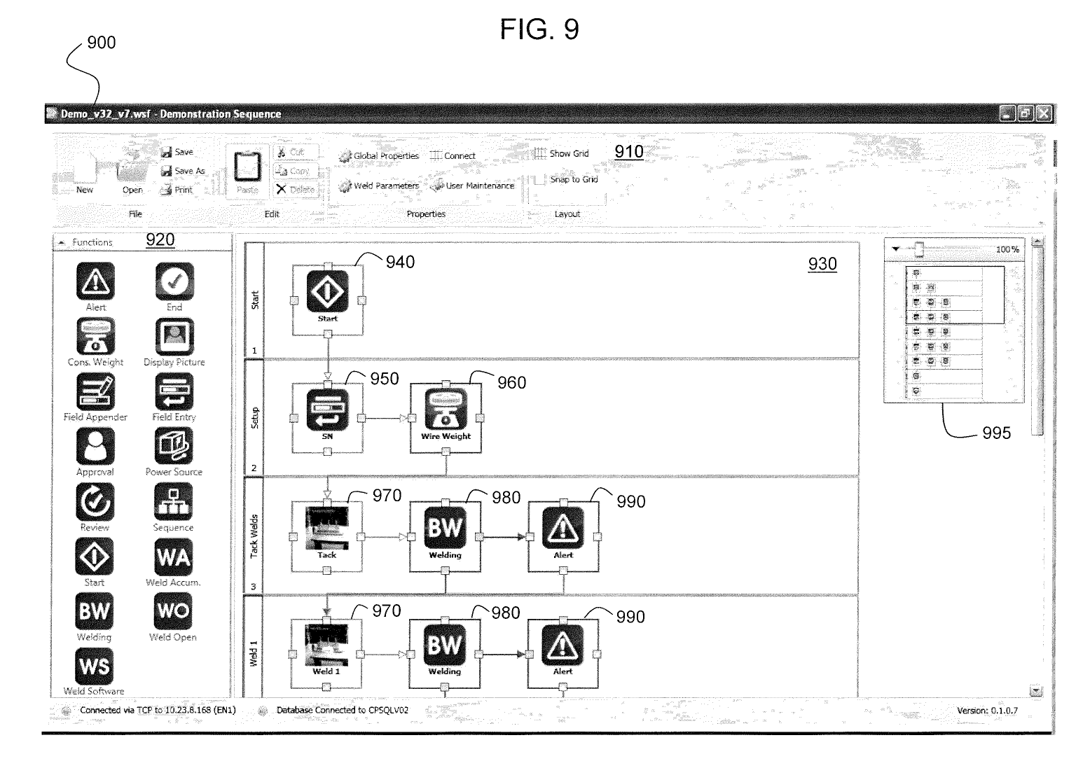

A welding sequence generated by the editor can contain many functional weld sequence steps that have to be defined by a user when generating the welding sequence. Such defined functional steps may contain many details that the operator does not need to know about when assembling a part. FIG. 9 illustrates an example embodiment of a flow chart display screen 900 provided by the weld sequence editor of FIG. 7. The display screen 900 includes a tool bar section 910, a function selection section 920, and a programmable flowchart section 930. The tool bar section 910 provides tools for file manipulation, editing, setting properties, and defining a layout of the screen. The function selection section 920 provides icons representing programmable welding sequence functions that may be selected by a user, placed in the programmable flowchart section 930 by the user, and defined or programmed by the user. The programmable flowchart section 930 provides a space for defining groups (functional weld sequence groups) of steps and programming the detailed functional steps for those groups for a welding sequence, and for programming the functional flow through those groups to define a welding sequence. The terms “icon”, “function”, and “step” may be used interchangeably herein.

Examples of some of the function icons are a “start” icon 940, a field entry icon 950, a consumable weight icon 960, a display picture icon 970, a welding icon 980, and an alert icon 990. Other function icons can exist as well, however. The start icon 940 (in the “start” group of FIG. 9) defines the beginning of a welding sequence. The field entry icon 950 and the consumable weight icon 960 (in the “setup” group of FIG. 9) define a first sequence of steps in the welding sequence. The display picture icon 970, the welding icon 980, and the alert icon 990 (in the “tack welds” group of FIG. 9) define a second sequence of steps in the welding sequence. The display picture icon 970, the welding icon 980, and the alert icon 990 (in the “weld 1” group of FIG. 9) define a third sequence of steps in the welding sequence. The groups of steps are logically tied (linked) together in a flowchart manner such that the welding sequence proceeds from “start” to the “setup” group, to the “tack welds” group, to the “weld 1” group, and so on. In this manner, a user of the WSE 745 on the personal computer 700 can “build” groups of detailed steps to generate a welding sequence which is exported to a weld sequence file (WFS). Again, each group of detailed steps represents an operator-level step that the operator experiences when using the welding job sequencer with the resulting weld sequence from the editor to assemble a part. Many of the detailed steps in a group, however, may be transparent to the operator.

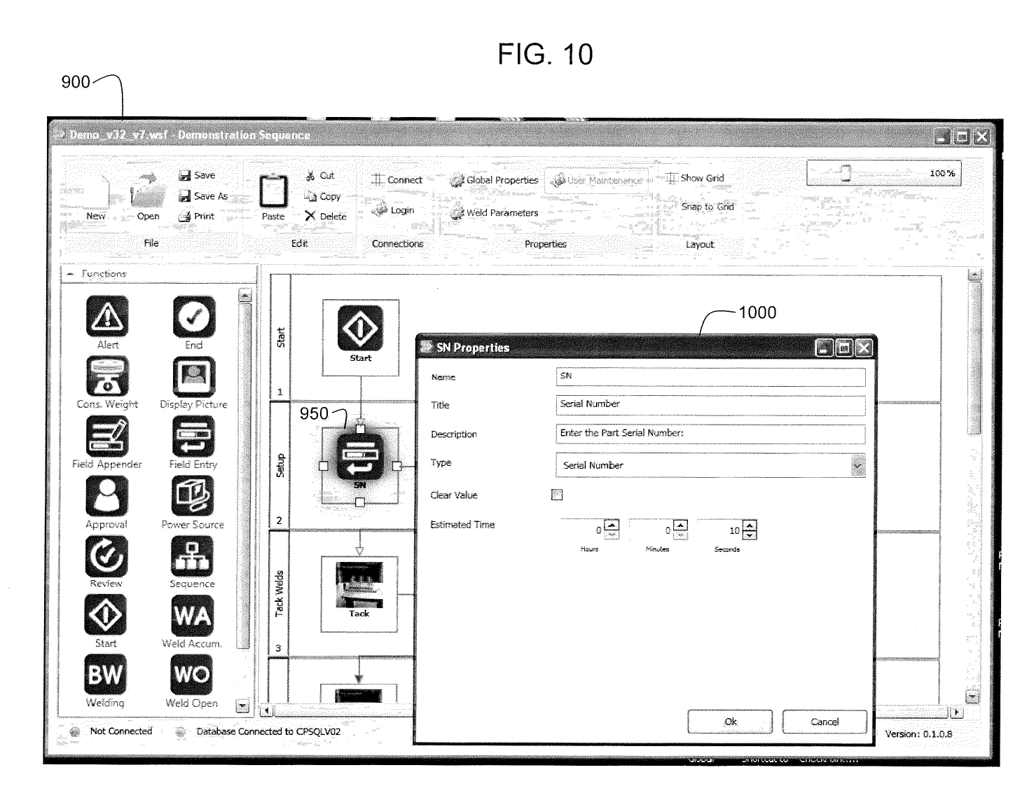

FIG. 10 illustrates an example embodiment of a properties window 1000 associated with the field entry icon 950 provided by the weld sequence editor 745 of FIG. 7. A user may double click on the icon 950 to cause the properties window 1000 to be displayed. Once displayed, the user can define the properties of the field entry icon 950 by filling in information in the various fields provided by the properties window 1000. For example, in FIG. 10, a user has entered “SN” in the name field, “Serial Number” in the title field, “Enter the Part Serial Number:” in the description field, and “Serial Number” in the type field. This defines the field entry icon 950 as a serial number entry function such that an operator will be directed by the welding job sequencer component 302 to enter a serial number for the part being assembled. The “clear value” check box allows the user to check this box to cause a current serial number to be cleared, forcing the operator to enter a new serial number. The “estimated time” area allows the user to enter an estimated amount of time that it should take for the operator to perform this field entry function.

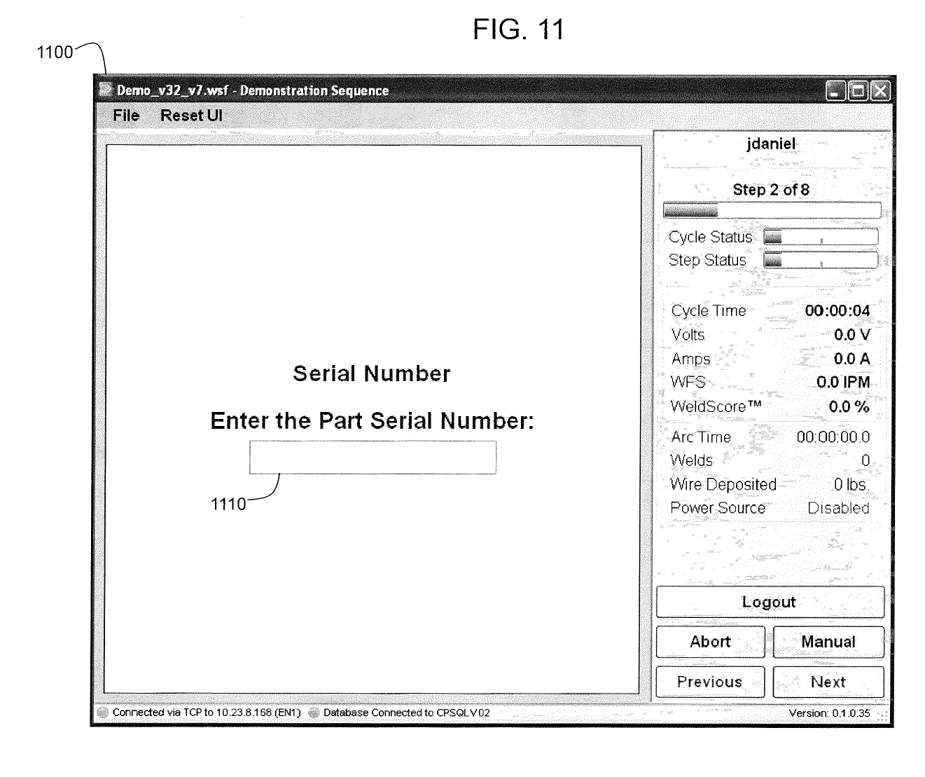

FIG. 11 illustrates an example embodiment of a serial number display screen 1100 provided by the welding job sequencer component 302 of FIG. 8 when the field entry step 950 is executed by the welding job sequencer component 302 as part of executing the welding sequence defined in the weld sequence file (WSF). The message title “Serial Number” and the message “Enter the Part Serial Number” are displayed to the operator on the display 810 along with a field entry box 1110 in which the operator is to enter the serial number of the part to be assembled. The operator may enter a serial number and then hit “Enter” or “Next” to proceed in the welding sequence.

“Cycle Status” and “Step Status” may be displayed in a display screen to an operator (e.g., see FIG. 11). Each detailed function step, or icon, in a welding sequence has a detailed parameter corresponding to the expected time to complete the function. Also, each group of steps has an expected time to complete by adding up the individual function times. When executing each step, the welding job sequencer component shows the actual execution time vs. the expected time with the “Step Status” gauge. The center of the “Step Status” gauge is the expected time. At the beginning, the bar in the gauge may be colored “green”, indicating that the step is progressing well. However, once the expected time is passed (the bar passes the center point), the bar in the gauge may be colored “red” to indicate that the step is taking too long to complete. The “Step Status” gauge may return to zero with every new step, in accordance with an embodiment.

The “Cycle Status” gauge works in a similar manner, but indicates if the total number of executed steps are progressing well (i.e., that the entire sequence is progressing well) or if the steps are taking too long to complete. The center of the “Cycle Status” gauge is the accumulation of all previous steps plus the current step, and the bar in the gauge indicates the total time of the entire sequence. The “Cycle Status” gauge does not return to zero with every new step, but the center point (and scaling of the gauge) is updated at the start of every step.

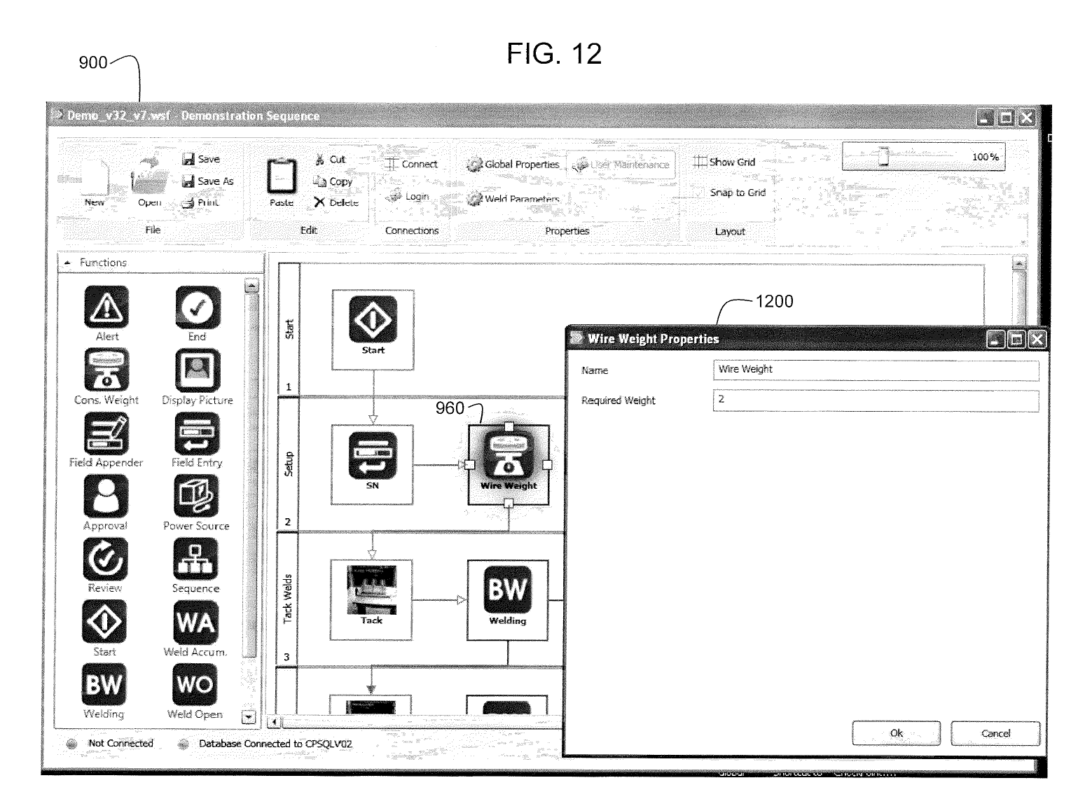

FIG. 12 illustrates an example embodiment of a wire weight properties window 1200 associated with the consumable weight icon 960 provided by the weld sequence editor 745 of FIG. 7. A user may double click on the icon 960 to cause the wire weight properties window 1200 to be displayed. Once displayed, the user can enter a name (e.g., “Wire Weight”) in the name field and the required weight of the consumable wire (e.g., “2” representing 2 lbs.) in the required weight field. When this step is executed by the welding job sequencer component 302, the actual weight of the loaded consumable welding wire in the welding work cell 304 is compared to the entered required weight (e.g., 2 lbs.). If the actual consumable welding wire weight is at least 2 lbs., the operator would not see any effect at all. However, if the actual consumable welding wire weight is less than 2 lbs., the operator would be notified (e.g., via the display 810) that the wire supply is low.

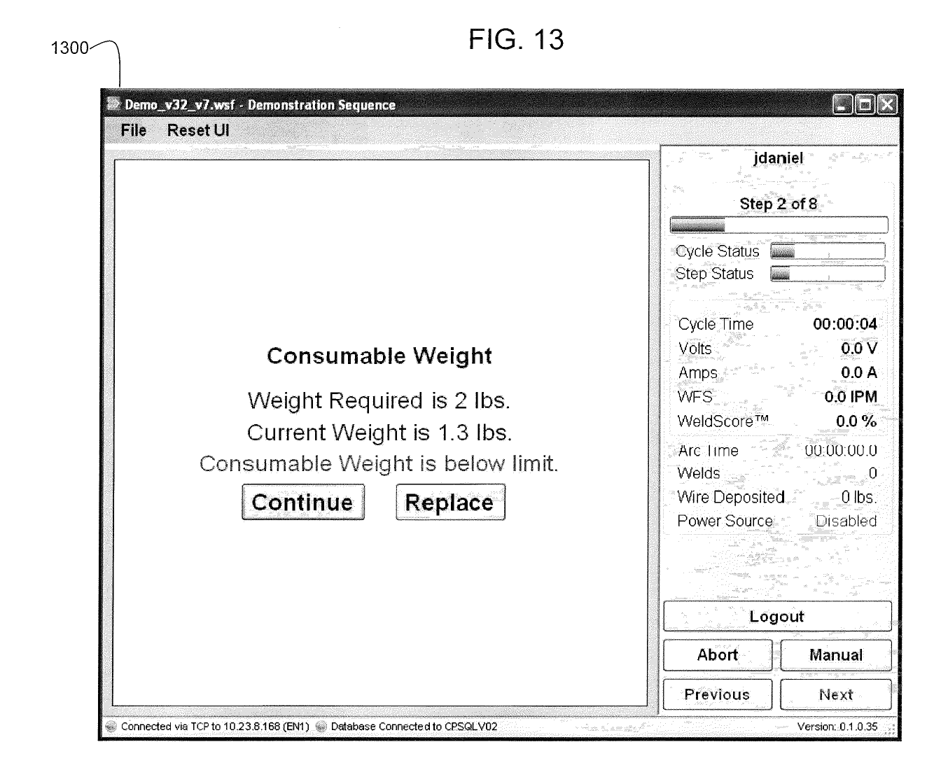

FIG. 13 illustrates an example embodiment of a consumable weight display screen 1300 provided by the welding job sequence component 302 of FIG. 8 when the consumable weight step 960 is executed by the welding job sequencer component 302 as part of executing the welding sequence defined in the weld sequence file (WSF) when the weight of the consumable welding wire is too low. As can be seen in FIG. 13, the operator is given the choice to continue with the current amount of wire (e.g., 1.3 lbs) or to replace the consumable welding wire to meet the requirement.

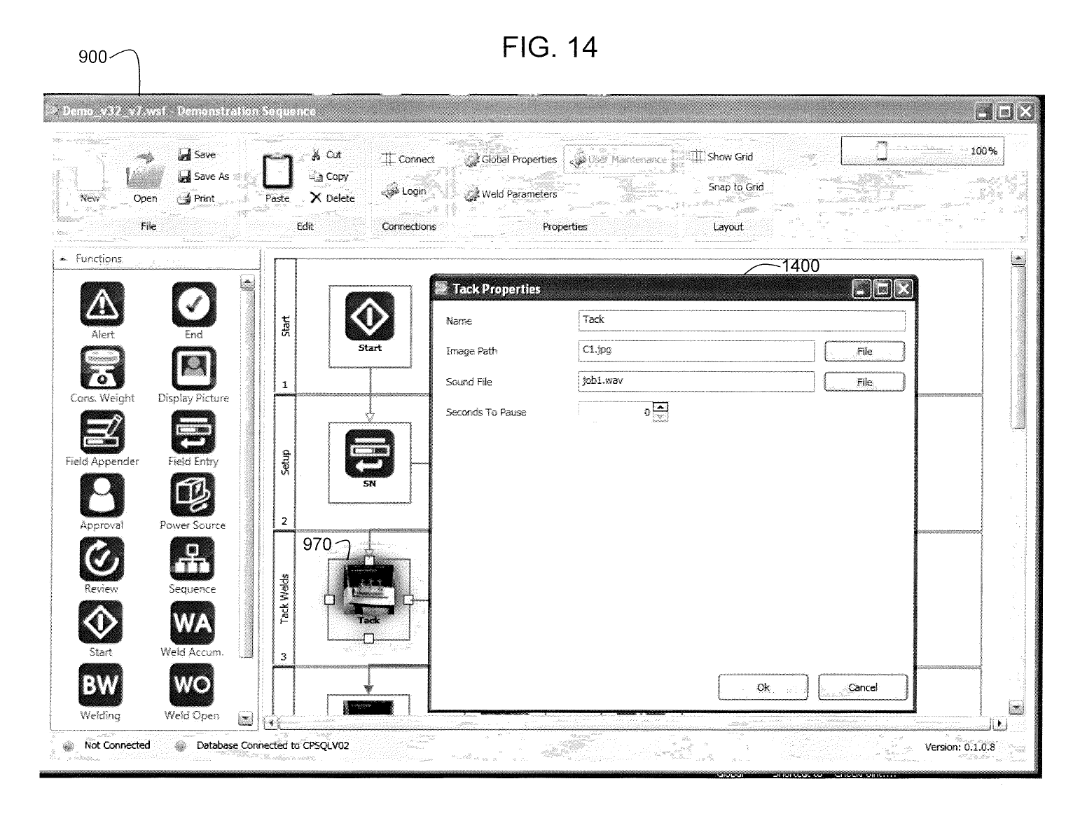

FIG. 14 illustrates an example embodiment of a tack weld properties window 1400 associated with the display picture icon 970 provided by the weld sequence editor 745 of FIG. 7. A user may double click on the icon 970 to cause the tack weld properties window 1400 to be displayed. Once displayed, the user can enter a name (e.g., “Tack”) in the name field, a picture file name in the image path field, and a sound file name in the sound file field. When this step is executed by the welding job sequencer component 302, the picture associated with the picture file (e.g. a picture showing two tack welds to be made on the part) is displayed to the operator and a sound (e.g., an “alert ding” or a verbal message) associated with the sound file is played. The picture file and the sound file can be stored somewhere on the system 800 (e.g., on a hard drive) or on a network to which the system 800 has access, for example.

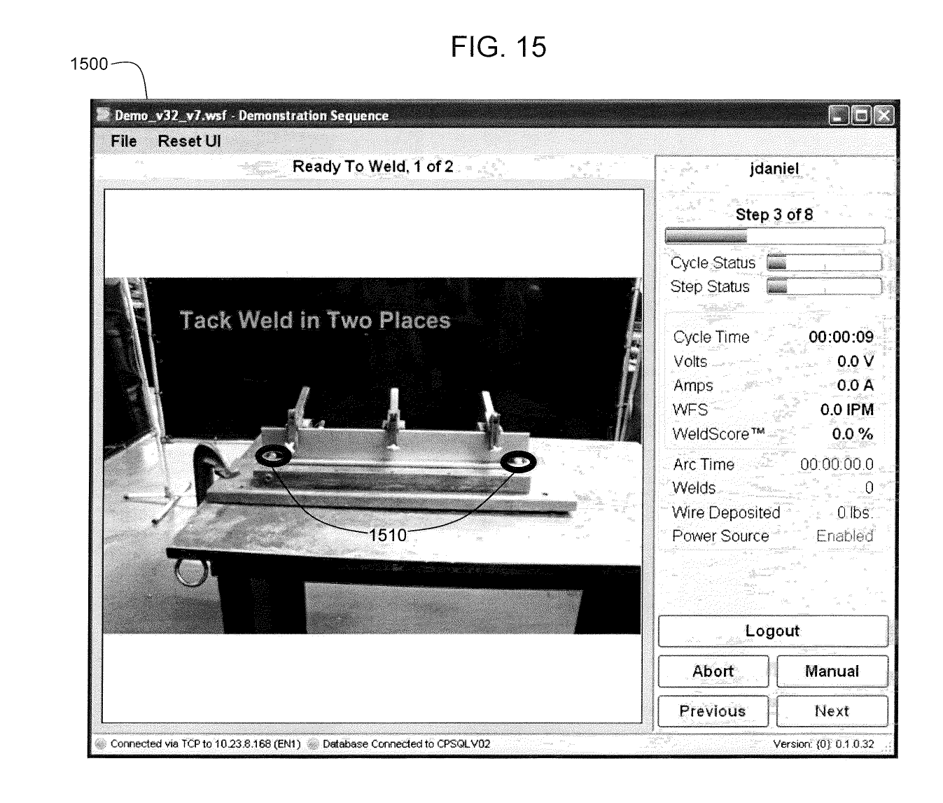

FIG. 15 illustrates an example embodiment of a tack weld display screen 1500 provided by the welding job sequencer component 302 of FIG. 8 when the display picture step 970 is executed by the welding job sequencer component 302 as part of executing the welding sequence defined in the weld sequence file (WFS). The defined picture file is accessed and the associated picture is displayed to the operator (e.g., on display 810) indicating to the operator the location of two tack welds 1510 that are to be made on the part. Furthermore, the defined sound file is accessed and played for the operator.

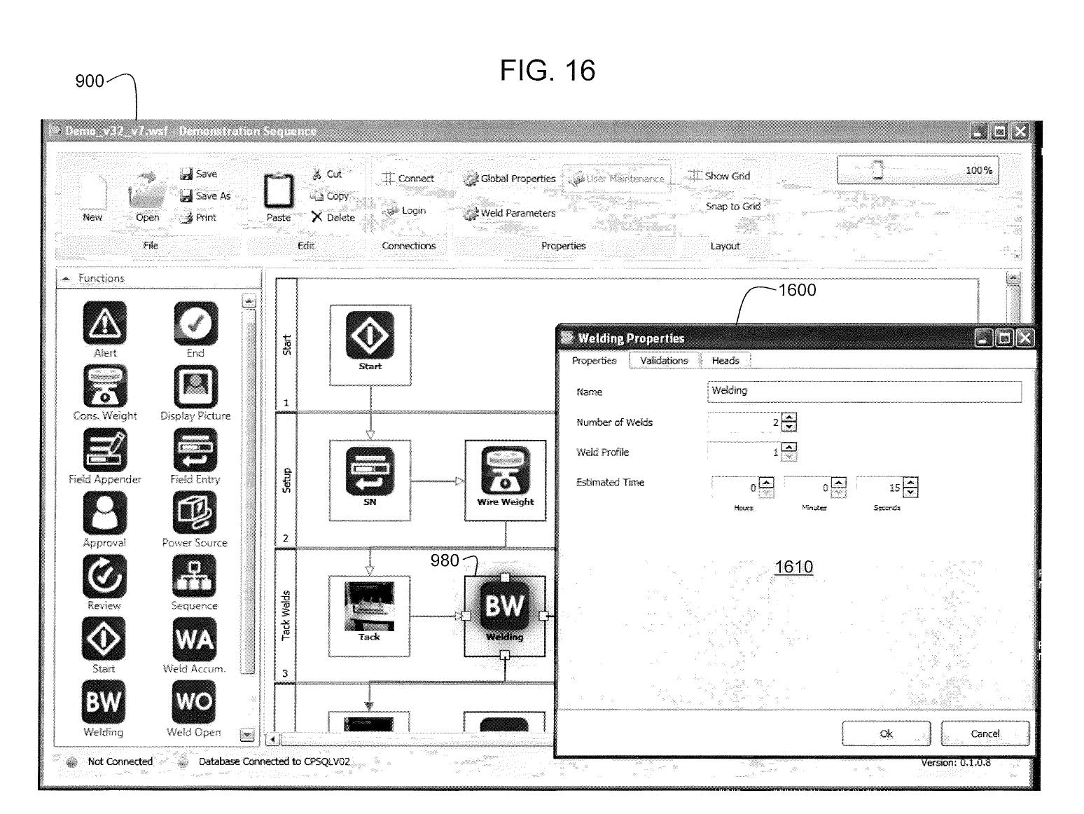

FIG. 16 illustrates an example embodiment of a welding properties window 1600 associated with the welding icon 980 provided by the weld sequence editor 745 of FIG. 7. The welding properties window 1600 provides a “properties” tab, a “validations” tab, and a “heads” tab. A user may double click on the icon 980 to cause the welding properties window 1600 to be displayed. Once displayed, under the “properties” tab display 1610, the user can enter a name (e.g., “Welding”) in the name field, a number of welds to be made with this function (e.g., 2) in the number of welds field, a weld profile number (e.g., 1) in the weld profile field, and an estimated time (e.g., 15 seconds) to complete the number of welds in the estimated time field. A weld profile is used to establish limits for the welding operation (e.g., to assist in limit checking for the welding current). For example, a welding power source may provide 200 or more weld profiles from which to select.

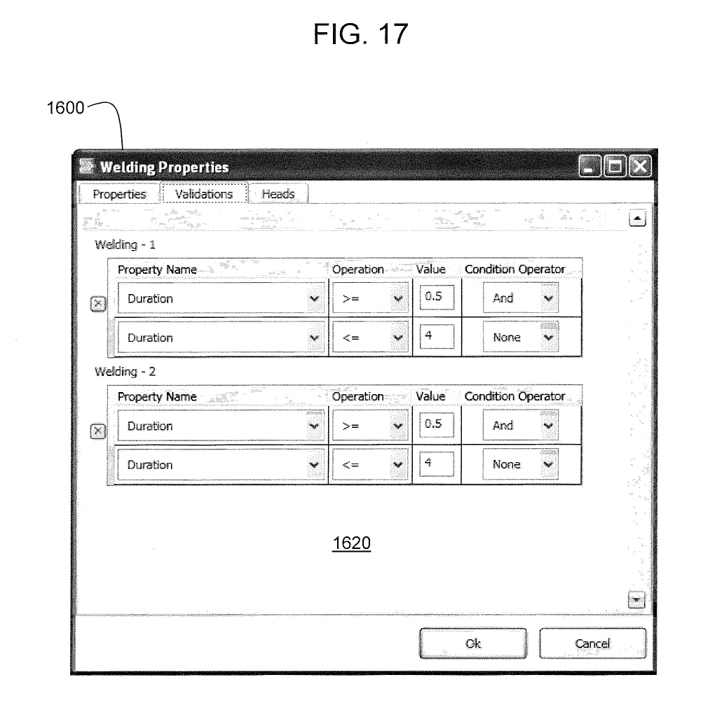

FIG. 17 illustrates an example embodiment of a “validations” tab display 1620 under the welding properties window 1600 provided by the weld sequence editor 745 of FIG. 7. Once a user clicks on the “validations” tab, the user can set the duration time of the welds to be made (e.g., weld 1 and weld 2) to be between some limits (e.g., between 0.5 seconds and 4.0 seconds). If the actual welding time falls outside of these limits during the welding operation, the welding function 980 will produce a “validation failed” exit condition.

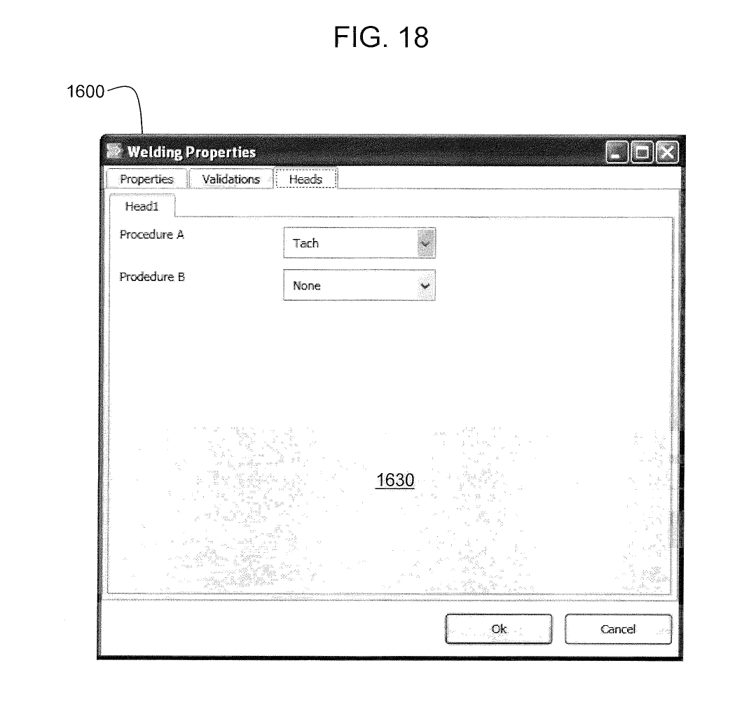

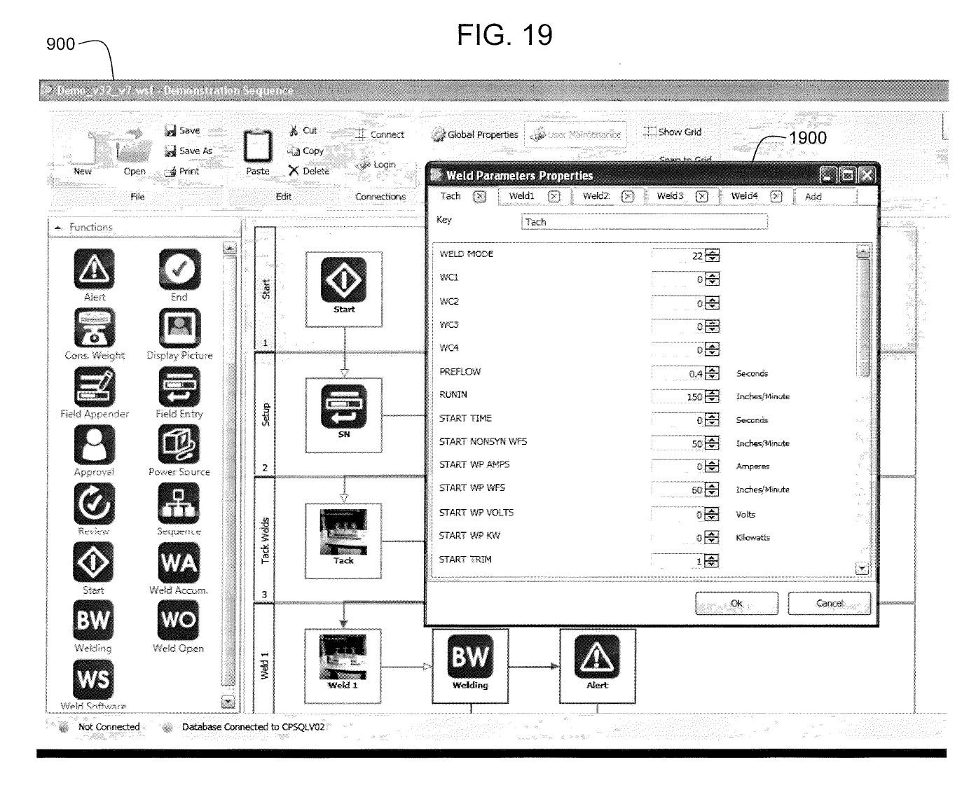

FIG. 18 illustrates an example embodiment of a “feed heads” tab display 1630 under the welding properties window 1600 provided by the weld sequence editor 745 of FIG. 7. A welding system may have multiple feed heads (wire feeding sources) from which to choose. Once a user clicks on the “feed heads” tab, the user can select a feed head (e.g., Head1) and proceed to define the welding procedures to be used for procedure A and procedure B. Procedures A and B are selections that are available through the welding torch, in accordance with an embodiment. For example, for procedure A, the “Tach” selection may be selected. The “Tach” selection corresponds to a set of defined welding parameters to be used. The defined welding parameters may be defined in another window as shown in FIG. 19. Other defined sets of welding parameter selections may be available as well.

FIG. 19 illustrates an example embodiment of a welding parameters window 1900 associated with the welding icon 980 provided by the weld sequence editor 745 of FIG. 7. A user may click on the “weld parameters” icon under the tool bar section 910 of the display screen 900 to display the window 1900. A welding procedure may have many parameters associated with it that can be set by the user. The window 1900 allows the user to view and edit many of the welding parameters associated with a welding step (e.g., the tack welding step 980). During operation by the welding job sequencer component 302, the welding parameters (e.g., welding mode and wire feed speed) are sent to the welding power source of the welding work cell 304 for that welding step. In accordance with an embodiment, a “weld parameter” library may be generated, stored, and maintained using the weld sequence editor 745. The “weld parameter” library may contain a baseline set of welding parameters that can be used by the various welding processes. However, any baseline weld parameter can be edited, if desired, via the welding parameters window 1900. The “weld parameter” library may be set up to help enforce consistency of the welding parameters since the welding parameters are not independently defined for every welding function. Furthermore, the “weld parameter” library may enable easy “global editing” of the weld parameters and, therefore, make the weld sequence creation process faster.

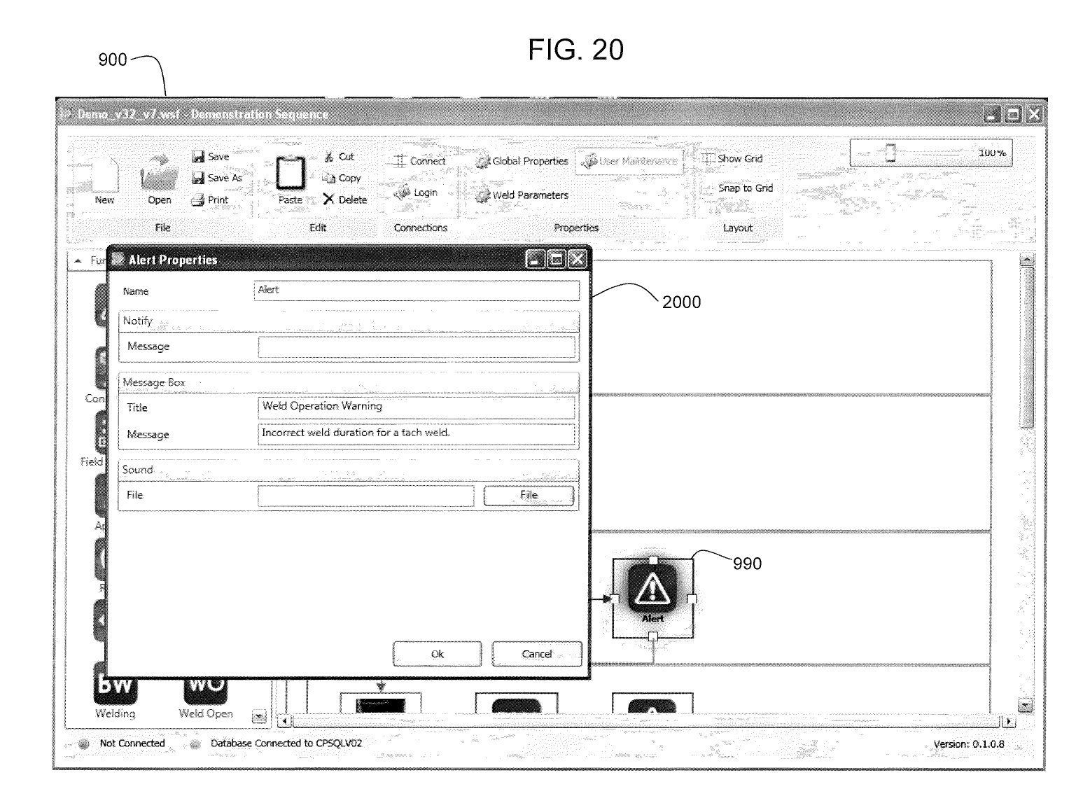

FIG. 20 illustrates an example embodiment of an alert window 2000 provided by the weld sequence editor 745 of FIG. 7. A user may double click on the alert icon 990 to cause the alert window 2000 to be displayed. Once displayed, the user can enter a name (e.g., “Alert”) in the name field, a title (e.g., “Weld Operation Warning”) in the title field, and a message (e.g., “Incorrect weld duration for a tach weld”) in the message field. Referring to FIG. 9, if the exit condition of the welding step 980=“failed” (e.g., a weld duration was too long), the welding sequence proceeds to the alert step 990 and displays the alert message to the operator. The operator is required to click on the “Ok” button, on the Alert message box displayed by the Weld Sequencer, before continuing with the welding sequence. Also, a sound file can be defined in the window 2000, and played if the alert function 990 is executed by the welding job sequencer component 302. The operator may choose to go back to the first step of the group by selecting “previous” in order to fix the weld. If the validation passes, the welding sequence proceeds with an exit condition of “passed” (from step 980) to step 970 of the next group of welding steps (e.g., “weld 1”) as directed by the connection between step 980 of group “tack welds” and step 970 of group “weld 1”.

In accordance with an embodiment, for many of the functional steps, the operator has the choice to go back to a previous step or continue forward in the weld sequence, based on the operator's judgment. In this manner, the operator is not overly constrained.

In summary, a weld sequence editor is provided that allows a user to create a flow chart of the functions for completing a set of work instructions and allows the user to organize the functions into logical groups of steps. The logical groups of steps are numbered, named, and the first function of each group is identified. When a weld sequence is executed, each logical group is a defined visible step to an operator. The logical groups are used to organize information and progress through a set of work instructions while multiple background functions execute without complicating the operator's view of the work flow. The weld sequence editor provides a method to organize the same work instructions into a detailed viewpoint for a user of the editor, and a summarized viewpoint for the operator of a work cell.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit of scope of the above discussed inventions. The embodiments and discussions herein can be readily incorporated into any of these systems and methodologies by those of skill in the art.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiments disclosed, but that the claimed subject matter will include all embodiments falling within the scope of the appended claims.

What is claimed is:

1. A weld sequence editor, said weld sequence editor comprising:
a computer having at least one processor, a computer memory, and a display device; and
a weld sequence editor software application stored on the computer memory including computer-executable instructions configured to be executed by the at least one processor,
wherein the weld sequence editor software application is configured to provide a graphical user interface having a tool bar section, a function selection section, and a programmable flowchart section, and
wherein the programmable flowchart section is configured to provide a space for a user to generate a welding sequence for assembling a part by:
defining functional weld sequence groups,
programming one or more functional weld sequence steps for each of the functional weld sequence groups, and
programming the functional flow through the functional weld sequence groups.

2. The weld sequence editor of claim 1, wherein the weld sequence editor software application is configured to generate an electronic weld sequence file having the welding sequence generated by the user.

3. The weld sequence editor of claim 2, wherein the computer includes a communication device configured to output the weld sequence file for use by a welding job sequencer.

4. The weld sequence editor of claim 3, wherein the communication device is configured as a wireless communication device.

5. The weld sequence editor of claim 1, wherein the computer is configured as one or more of a tablet computer, a desktop computer, a hand-held mobile device, or a workstation.

6. The weld sequence editor of claim 1, wherein the display device is a touch-screen display device configured to facilitate use of the graphical user interface.

7. The weld sequence editor of claim 1, further comprising a user input device providing one or more of a keyboard and a mouse to facilitate use of the graphical user interface.

8. A welding system comprising:
the weld sequence editor of claim 1;
a welding job sequencer configured to implement the welding sequence; and
a welding work cell having a welding power source configured to be used by an operator to produce one or more welded parts in accordance with the welding sequence.

9. The welding system of claim 8, further comprising a display device operatively connected to the welding job sequencer.

10. The welding system of claim 9, wherein the display device is a touch-screen display device providing user input capability.

11. The welding system of claim 8, wherein the welding work cell includes one or more of a wire feeder, a welding cable, a welding tool, consumable welding wire, a consumable welding electrode, a non-consumable welding electrode, a workpiece connector, and one or more workpiece parts to be welded.

12. The welding system of claim 11, wherein the welding job sequencer is configured to interact with one or more of the welding power source, the wire feeder, or the welding tool when implementing the welding sequence.

13. The welding system of claim 8, wherein the weld sequence editor includes one or more of a tablet computer, a desktop computer, a hand-held mobile device, or a workstation.

14. The welding system of claim 8, further comprising a user input device providing one or more of a keyboard and a mouse to facilitate use of the welding job sequencer by an operator.

15. A method of generating a weld sequence, said method comprising:
defining functional weld sequence groups in a programmable flowchart section of a graphical user interface provided by a weld sequence editor software application running on a computer;
selecting functional icons, representative of functional weld sequence steps, from a function selection section of the graphical user interface and populating the functional weld sequence groups with the selected functional icons in the programmable flowchart section; and
linking the functional icons and the functional weld sequence groups in the programmable flowchart section to program a functional flow through the functional weld sequence groups of functional weld sequence steps, resulting in a welding sequence.

16. The method of claim 15, further comprising exporting the welding sequence to an electronic file using a tool bar section of the graphical user interface, where the electronic file is stored in a memory of the computer.

17. The method of claim 16, further comprising wirelessly transmitting the electronic file from the computer to a welding job sequencer component.

18. The method of claim 15, further comprising using the graphical user interface to modify the welding sequence by one or more of deleting a functional weld sequence step from a functional weld sequence group or adding a functional weld sequence step to a functional weld sequence group.

19. The method of claim 15, further comprising using the graphical user interface to modify the welding sequence by modifying one or more properties associated with a functional weld sequence step.

20. The method of claim 15, further comprising using the graphical user interface to modify the welding sequence by modifying one or more parameters associated with a functional weld sequence step.
